(19) United States
(12) Patent Application Publication
(10) Pub. No.: US 2008/0215551 A1
(43) Pub. Date: Sep. 4, 2008

(54) Physically Locating Content in a Network

(75) Inventors: Wilhelmus Henrica Gerarda Maria Van Den Boomen, Eindhoven (NL); Marc Andre Peters, Eindhoven (NL); Godefridus Antonius Maria Crienen, Baarlo (NL); Freddy Snijder, Eindhoven (NL); Esko Olavi Dijk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,541

(22) PCT Filed: Aug. 29, 2006
(86) PCT No.: PCT/IB2006/052993

§ 371 Date: Mar. 3, 2008

(30) Foreign Application Priority Data
Sep. 5, 2005 (EP) 05108114.9

(51) Int. Cl. G06F 7/06; G06F 17/30

(52) U.S. Cl. 707/3; 707/E17.107

(57) ABSTRACT

A system (11, 50) and method is disclosed to be used for physically locating content (12) in a network (10). Further, a device is disclosed for use in the system and a computer program product enabling the disclosed method. The system comprises an input means (53) allowing a user to identify content (12) which is to be physically located, for example, via a computer or television user interface. A device (11) storing the content (12) is identified physically within the network. The device provides a signal (45) which the user is physically susceptible to, for example, a visual indication. The user is therefore assisted in the physical location of content that has been virtualised in the network. Such a system is especially useful when the device comprised within the network is a portable storage device that the user would like to quickly locate and take away.

### BACKGROUND OF THE INVENTION

The invention relates to a system for physically locating content in a network.

The invention further relates to a device for physically locating content in a network.

The invention further relates to a method of physically locating content in a network.

The invention further relates to a computer program product.

In the area of consumer entertainment the use of networks is growing rapidly due to the low incremental cost of adding personal computer technology to home entertainment systems. Once content enters an in-home distributed entertainment network it is accessible anywhere within the network and for the user its physical location becomes a virtual one. Whilst this is acceptable in most circumstances it does have certain disadvantages. For example, when a user wants to take a certain item of content out of the realms of the network he or she currently has few options. The user can move or copy the content to a portable storage device that is well known from the state of the art, for example CDs, DVDs, floppy discs or USB sticks. However, for some content such as video files these actions can take long periods of time, even on modern hardware. Further disadvantages are that the user is required to perform numerous tedious tasks, such as acquiring a storage medium with free space, inserting the storage medium and initiating the content transfer. This is equally true for home networks environments making use of peer-to-peer networking technology. The term peer-to-peer refers to a type of transient Internet network that allows a group of users with the same networking program to connect with each other, directly access files from one another's data storage and provide other services among each other via the network. Various peer-to-peer configurations exist, such as a centralized configuration, a decentralized configuration and a controlled centralized configuration. “Napster” is an example of a centralized configuration. “Gnutella” and “Kazaa” are examples of decentralized networks. “Morpheus” is an example of a controlled decentralized configuration. For a brief discussion of peer-to-peer network architectures see, e.g., “Stretching The Fabric Of The Net: Examining the present and potential of peer-to-peer technologies”, Software & Information Industry Association (SIIA), 2001.

Another option for physically locating content in the network is that the user remains mentally aware of the physical location of the content that has been virtualised in the network. This is reasonable for small networks, but as the number of physical devices comprised within the network increases, which is foreseen by the inventors, such a responsibility becomes a significant burden to the user. Thus the ease of physically locating content within the network is reduced in large networks.

### BRIEF SUMMARY OF THE INVENTION

It is an object of the invention to provide a system of the type defined in the opening paragraph which is capable of physically locating content within a network.

In order to achieve the object defined above, with a system according to the invention, characteristic features are provided so that a system according to the invention can be characterized in the way defined below, that is:

A system for physically locating content in a network comprising means for identifying a physical device within the network upon which the content is stored having an input for identifying the content to be physically located and having an output identifying the physical device; and means for generating a user susceptible physical indication on the physical device identified by the means for identifying a physical device.

A device according to the invention can be characterized in the way defined below, that is:

A device for physically locating content in a network comprising means for identifying that the content has been located and having a content located output; and means for generating a user susceptible physical indication on the device in response to the content located output from the means for identifying that the content has been located.

A method of physically locating content within a network according to the invention can be characterized in the way defined below, that is:

A method of physically locating content within a network, the method comprising the method steps of identifying the content in the network which is to be physically located; identifying a physical device upon which the content is located; and generating a user susceptible physical indication on the physical device upon which the content is located.

A computer program product according to the invention can be characterized in the way defined below, that is:

A computer program product directly loadable into the memory of a programmable device, comprising software code portions for performing the steps of a method of physically locating content within a network according to the invention.

The measures according to the invention provide the advantage that it is possible for a user to physically locate content within a network. Since a user can provide input to identify content to be physically located within the virtualized storage of the network and the distributed network can identify the physical device upon which the content is located the further measure of providing a physical indication that a user is physically susceptible to enables the user to easily locate the device producing the physical indication and therefore the device comprising the content to be physically located.

The measures as claimed in claim 2, claim 10 or claim 15 provide the advantage that the strength of the physical indication can be made dependent upon the relevance of the content to be located to each individual device in the system. Devices with very relevant content would provide stronger physical indications enabling a user to identify the most relevant device even in situations where the content to be located is identified in a non-specific manner.

It has proved to be particularly advantageous if the measures of claim 3, claim 11 or claim 16 are provided. This achieves the advantage of allowing the use of semantically rich queries to be formed for identifying the content to be located in the network.

The measures as claimed in claim 4 or claim 17 provide the advantage that the strength of the physical indication produced by each device within the system can be made dependent upon the relevance of the content to be located to each device in the system taking into account the relevance of the content to the further devices in the system.

The measures as claimed in claim 5 provide the advantage that it is easy to identify the content to be physically located.

The measures as claimed in claim 6 provide the advantage that the system can be comprised of simple devices that can be produced at low cost due to the limited functionality required.

The measures as claimed in claim 7 provide the advantage that the device physically comprising the content to be located can locate the content and generate a physical indication independently.

The measures as claimed in claim 8 or claim 13 provide the advantage that physical indication is clear to a user allowing easy physical location of the content.

The measures as claimed in claim 12 provide the advantage that the device physically comprising the content to be located can locate the content independently.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 shows a prior art system for physically locating content in a network.

FIG. 2 shows a second prior art system for physically locating content in a network.

FIG. 3 shows a schematic diagram of an embodiment of a system according to the invention.

FIG. 4 shows a schematic diagram of an embodiment of a device according to the invention.

FIG. 5 shows a schematic diagram of a device for identifying content and the relation to the system according to the invention.

FIG. 6 shows a schematic diagram of the relation between a device for locating the content and a device for identifying content in the system according to the invention.

FIG. 7 shows a second embodiment of a system according to the invention.

FIG. 8 shows a third embodiment of a system according to the invention.

FIG. 9 shows a fourth embodiment of a system according to the invention.

FIG. 10 shows a schematic diagram of a second embodiment of a device according to the invention.

FIG. 11 shows a flow chart of a process for physically locating content in a network according to the invention.

FIG. 12 shows a flow chart of a second process for physically locating content in a network according to the invention.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION OF THE INVENTION

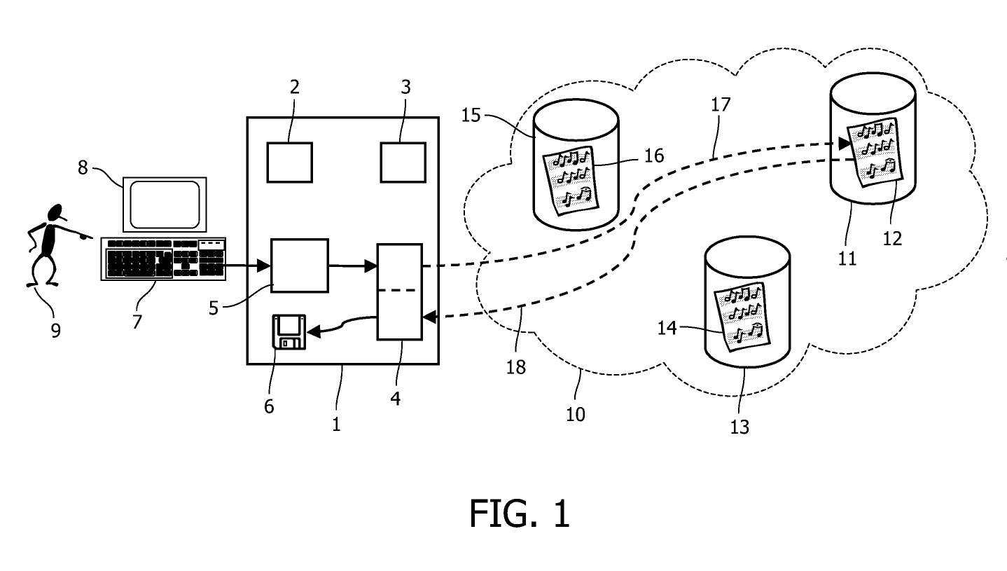

FIG. 1 shows a prior art system as introduced already introduced. A user 9 interacts with a user device 1, which could be a personal computer, using an input means 7, such as a mouse or keyboard etc., to identify content 12 of interest to the user 9 that a content locator 5 should locate within a network 10. The content locator 5 can be a file manager, able to address networked file systems such as a Network File System, NFS, or Common Internet Files System, CIFS, also referred to as a Samba file system. The content locator 5 can also make use of a database to locate content. The network 10 further comprises a first device 11 comprising the content 12 to be located, a second device 13 comprising content 14 not of interest to the user 9 and a third device 15 comprising content 16 also not of interest to the user 9. The user device 1 generally comprises a processor 2, memory 3 and a communication means 4, such as a network interface. A user 9 wishing to acquire the content 12 and physically transport the content 12 beyond the realms of the network 10 must either move or copy the content 12 to a portable storage device 6. This is necessary because although the system is capable of identifying the device 11 where the content 12 is stored the identifiers used offer no hints to the user 9 in the physical world. For example, the device 11 may be identified by the name of a shared folder, an Internet Protocol, i.e. IP, address or a descriptive device name, such as “Printer”. Whilst it is possible to uniquely identify the physical location of each device such an action would only make sense for parts of the infrastructure that are not portable. In the home environment, it is envisioned that all components of the home network, even personal desktop computers, are portable to at least some degree. This would require tedious maintenance by the user 9. The user is then left with little option, but to perform the copy or move which can take many minutes for large video files, even for modern storage devices and interfaces. The user is furthermore required to perform numerous tedious tasks, such as acquiring a storage medium with free space, inserting the storage medium and initiating the content transfer.

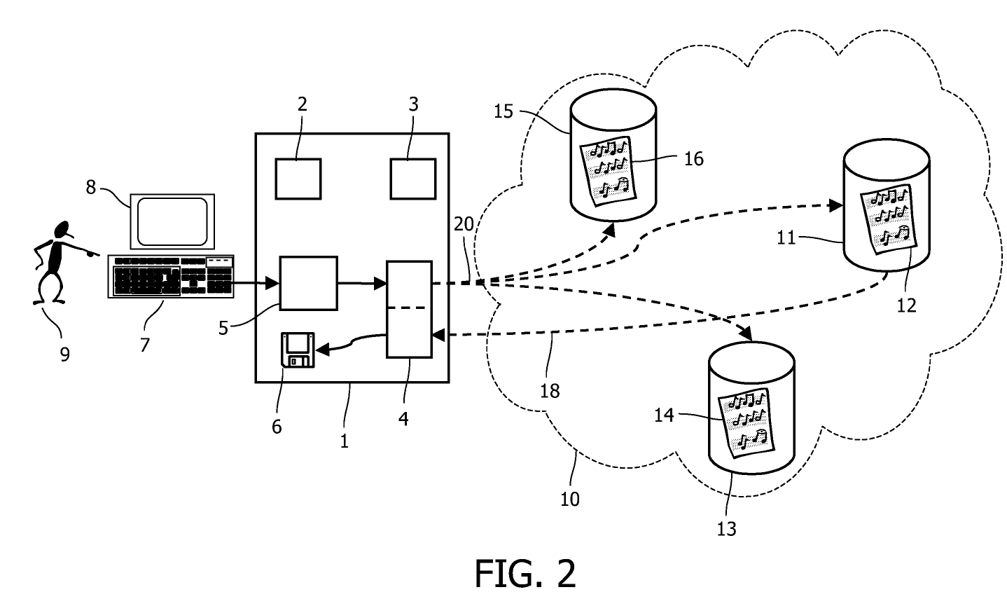

In FIG. 2 a second prior art system uses a peer-to-peer network to distribute a query 20 to first device 11, the second device 13 and the third device 15 whom all store content on the network 10. In such a prior art embodiment the first device 11, the second device 13 and the third device 15 comprised in the network can process the query 20. However, as is required in the prior art embodiment of FIG. 1, physical access to the content requires a copy or move action to a portable storage device 6 incurring a significant time delay.

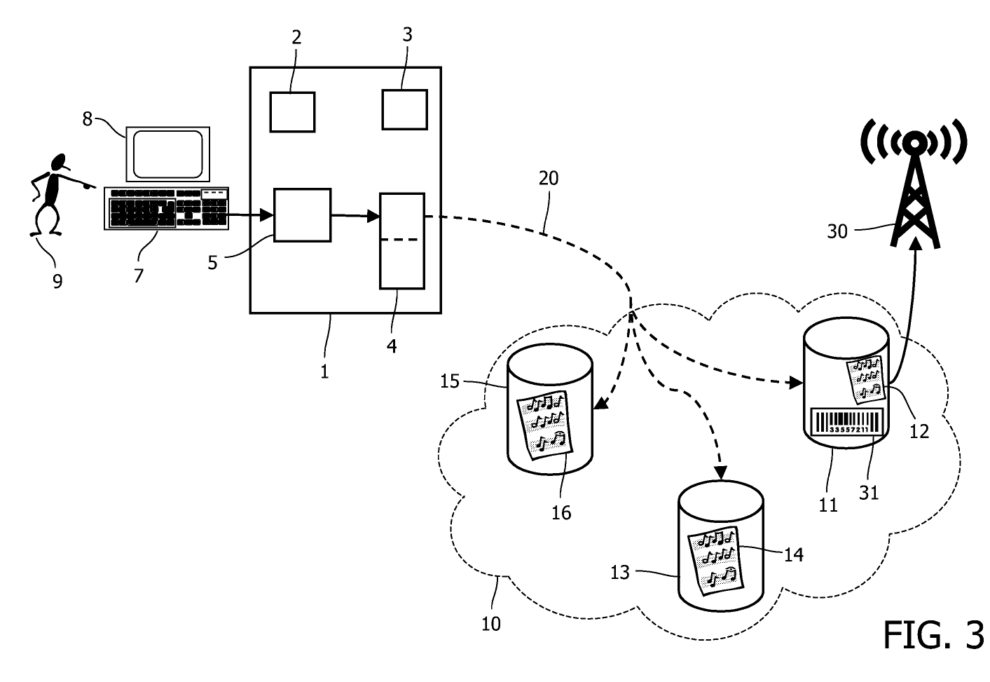

An embodiment of the invention is shown in FIG. 3. The user 9 interacts with the user device 1 using the input means 7, which can be any suitable input means, such as a keyboard, mouse, touch-screen, remote control or voice-controlled input. The input can be pre-processed to abstract from the modality of the input means 7 making any request input by the user 9 more general in form. A display 8 is used to provide feedback to the user 9 during operation of the user device 1. In the embodiment of FIG. 3 the content locator 5 creates query 20, optionally performing pre-processing to abstract the query 20 into a standardized query form. Such a standardized form may conform to a Universal Plug and Play (UPnP) query, a Structure Query Language (SQL) query for a relational database, a Sesame RDF Query Language (SeRQL) query, a JXTA Content Management Service (CMS) query or even a proprietary de-facto standard. In the known manner the query 20 is distributed in the network 10 to the first device 11, the second device 13 and the third device 15. Preferably an identifying means 31 can be used to uniquely identify the devices in the network 10, such as a unique number randomly, but uniquely, assigned, a serial number, an Internet Protocol (IP) number, a Media Access Control (MAC) address. The identifying means 31 can also be used to uniquely identify the content 12 in the network 10, in such a case, the identifying means 31 can perform known content analysis procedures on the content 12 to identify features of the content 12 uniquely identifying it.

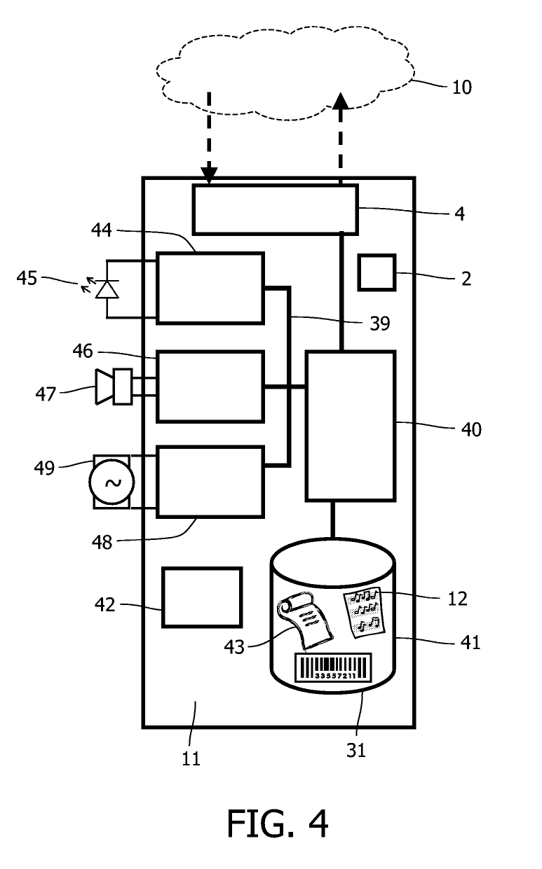

First device 11, an embodiment of which is shown in detail in FIG. 4, receives the query 20 via communication means 4 of the known type, such as a wired or wireless network interface card, modem, further typical known means are via a Universal Serial Bus (USB), a Bluetooth, a Wireless Fidelity Connection (WI-FI), communication according to the Near Field Communication (NFC) standard, etc. Query processor 40, which may be implemented as software on a more general-purpose processor 2, co-operates with memory 42 to execute the query 20 on the first device 11. The query processor 40 can access a storage unit 41, which in this embodiment can comprise the content 12 to be located, metadata 43 related to the content 12 and an identifying means 31. The metadata 43 may comprise simple textual keywords, but may also be embedded within the content 12 according to known standards, such as EXIF, ID3, an MPEG standard or according to a proprietary means. Preferably the query processor 40 in performing the query 20 makes use of the metadata 43. The query processor 40 generates a query result 39 which is output to a suitable indication means 30, shown in FIG. 3, for generating an indication that a user is physically susceptible to. The suitable indication means 30 may comprise a visual indication means 45, such as a light emitting diode (LED), a bulb etc. The visual indication means 45 may be controlled by a visual controller 44 capable of translating the query result 39 into a control signal suitable for the visual indication means 45. The suitable indication means 30 may also comprise an acoustic indication means 47, such as a speaker, buzzer etc. The acoustic indication means 47 may be controlled by an acoustic controller 46 capable of translating the query result 39 into a control signal suitable for the acoustic indication means 47. The suitable indication means 30 may also comprise a vibrational indication means 49, such as a motor etc. The vibrational indication means 49 may be controlled by an vibration controller 48 capable of translating the query result 39 into a control signal suitable for the vibrational indication means 49. The common feature among these indication means 30 is that the attention of the user 9 is directed towards the first device 11 comprising the content 12 to be located. Any indication means 30 capable of generating an indication that the user 9 is susceptible to, i.e. can detect and receive or perceive, is suitable.

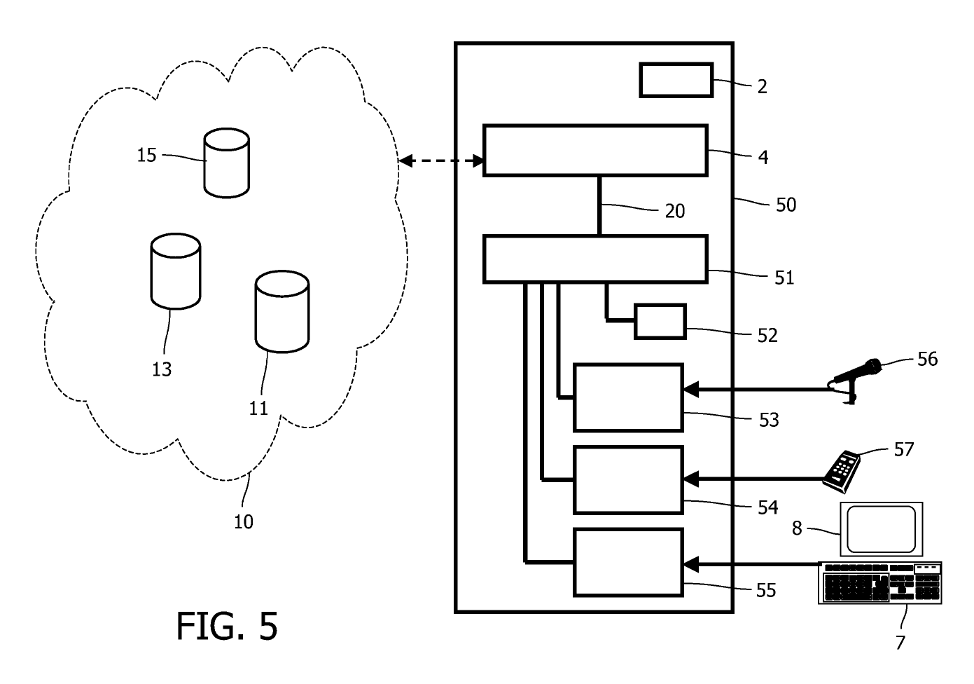

In the embodiment of FIG. 5 a user interface device 50 is shown with which the user 9 can interact for identifying the content to be physically located. The user interface device 50 may be a personal computer, a television, a set top box, etc. The user interface device 50 may even be implemented in a portable storage device with processing capabilities. The identification of the content 12 to be located can be via any suitable means, for example, via a keyboard 7, pointing device, mouse, touch screen, remote control 57 or acoustic input 56, such as a microphone. The identification of the content 12 to be located can also be via a visual input, such as a camera, this is especially useful for identifying visual objects, such as pictures. Preferably, the input is pre-processed to abstract from the modality of the input means making any request input by the user 9 more general in form. For example, a keyboard input processor 55 can accept the input from the keyboard 7 and process it to a form suitable for a query construction processor 51 to use. A voice input processor 53 can similarly process the acoustic input 56 into a form suitable for the query construction processor 51. As a further example, a remote control input processor 54 can process the remote control input 57 into a form suitable for the query construction processor 51.

The query construction processor 51 creates the query 20, of FIG. 3, again optionally performing pre-processing to abstract the query 20 into a standardized query form. In the known manner the query 20 is distributed in the network 10 to the first device 11, the second device 13 and the third device 15. The query construction processor 51 can be implemented as software on a more general-purpose processor 2 cooperating with memory 42.

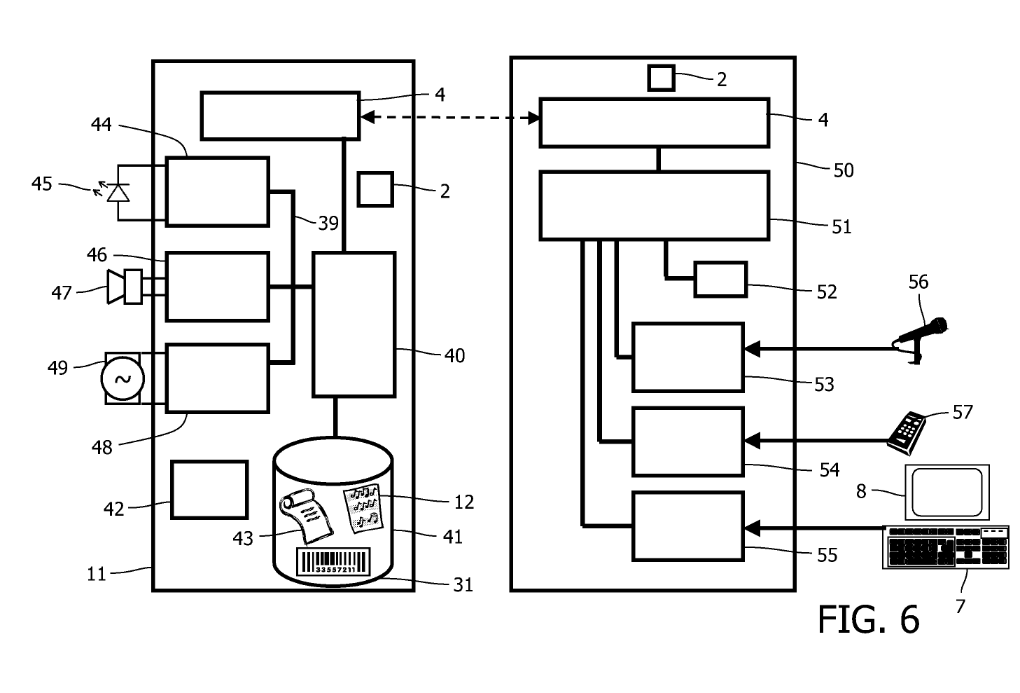

In the embodiment of FIG. 6 the relation between the user interface device 50 and the first device 11 is shown. The user interface device 50 accepts input from the user 9 to identify the content 12 to be located. The input may be pre-processed and passed to the query construction processor 51 which generates the query 20 for transmission within the network 10. First device 11 being comprised within the network 10 receives the query 20 via a known communication means 4 and executes the query 20 on the query processor 40, preferably making use of the content 12, the metadata 43, the identifying means 31, all of which are comprised within the storage unit 41. The query processor 40 generates the query result 39 which is passed to the visual indication controller 44, an acoustic controller 46 and/or a vibrational controller 48. The visual controller 44 generates a signal suitable for driving the visual indication means 45. The acoustic controller 46 generates a signal suitable for driving the acoustic indication means 47. The vibrational controller 48 generates a signal suitable for driving the vibrational indication means 49. Any of the processors mentioned here may be implemented as software on a general-purpose processor 2 cooperating with memory 42.

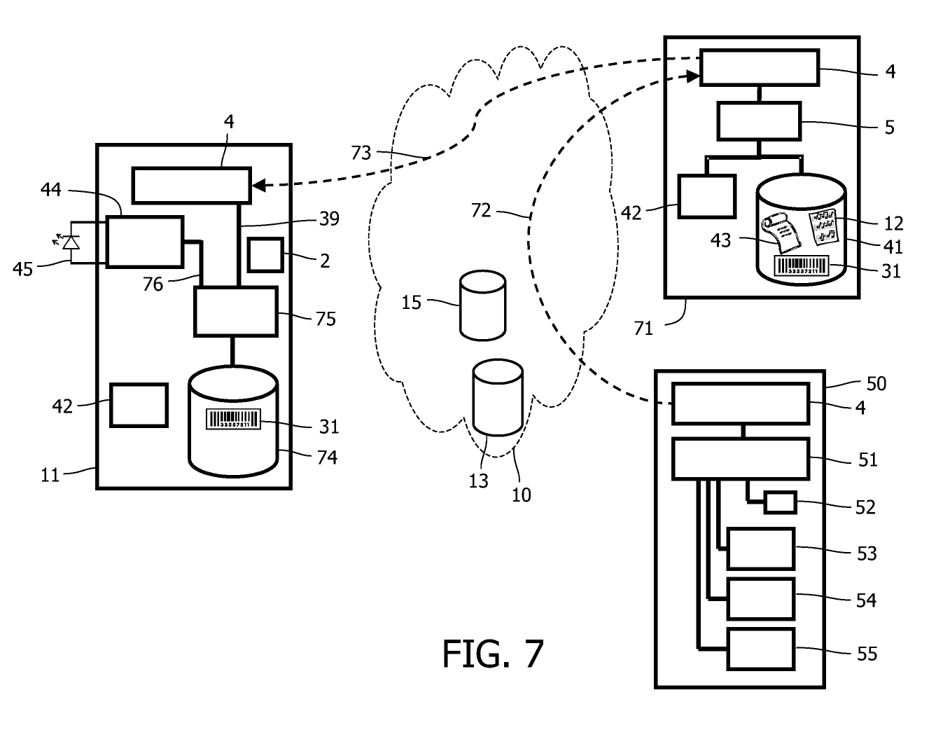

In the embodiment of FIG. 7 the user interface device 50 already described preferably communicates with a storage server 71 within the network 10, rather than directly the first device 11. A query for content to be located 72 is passed from the user interface device 50 to the storage server 71. The storage server 71 comprises the storage unit 41 already described, which further comprises the identifying means 31, the content 12 to be located and the metadata 43, which is related to the content 12. The storage server 71 has a content locator 5 capable of locating the content 12, if possible, i.e. when it is stored within the storage unit 41. The content locator 5 preferably comprises a query processor 40 for executing the query for content to be located 72. The content locator 5 produces a query result for content to be located 73, which, of course, depends upon the ability to locate the content 12 within the storage unit 41. The query result for content to be located 73 is transmitted using a known communication means 4 to the first device 11.

The advantage of splitting the functionality according to the embodiment of FIG. 7 is that the first device 11 is only required to be able to identify messages for itself and respond to the messages by providing a physical indication for the user 9. The cost of the components for such a device are then low since the only storage required is for the identifying means 31 and the processing capabilities required are also limited. In such an embodiment the first device 11 can operate as a token that the user 9 has assigned to represent the content 12 to be located. This token is therefore a physical object that can act as a key to access the content 12. For example, the user 9 can instruct the storage server 71 to make a symbolic link between the identifying means 31 and the content 12 to be located. Thereafter, any search for the content 12 will lead the first device 11 to provide a physical indication to the user 9. The reverse is also true, any interaction between the first device 11 and the user 9 can, in fact, cause the system to perform actions upon the content 12.

In the embodiment of FIG. 7 the first device 11 comprises a means for identifying that the content 12 has been located, such a means can be an identifier tester unit 75 for testing whether the query result for content to be located 73 is, in fact, intended for the first device 11. Preferably, the identifying means 31 is used for this purpose with the identifying means 31 being stored in an identifier storage unit 74. The identifying means 31 can be used to uniquely identify the devices in the network 10, such as by using a unique number randomly, but uniquely, assigned, a serial number, an Internet Protocol (IP) number, a Media Access Control (MAC) address or it can also be used to uniquely identify the content 12 in the network 10. This is preferable since the query result for content to be located 73 can optionally be efficiently broadcast to all devices within the network 10, with only the intended recipient, or recipients, responding. The identifier tester unit 75 has a content located output 76 indicating that the content has been located and that the first device 11 has been identified to generate an indication that the user 9 is physically susceptible to. The content located output 76 is connected to the input of the visual controller 44, arranged to generate a suitable signal for the visual indication means 45. The user 9 can then easily locate the first device 11 which has been defined to relate to the content 12 to be located. Of course, other physical indication means could also be used. In implementing the identifier tester unit 75 a general-purpose processor 2 and memory 42 can be used. The second device 13 and the third device 15 which may be comparable to the first device 11 will generally not succeed in identifying the content 12 and provide a positive result on their respective content located outputs and therefore not generate a physical indication for locating the content 12.

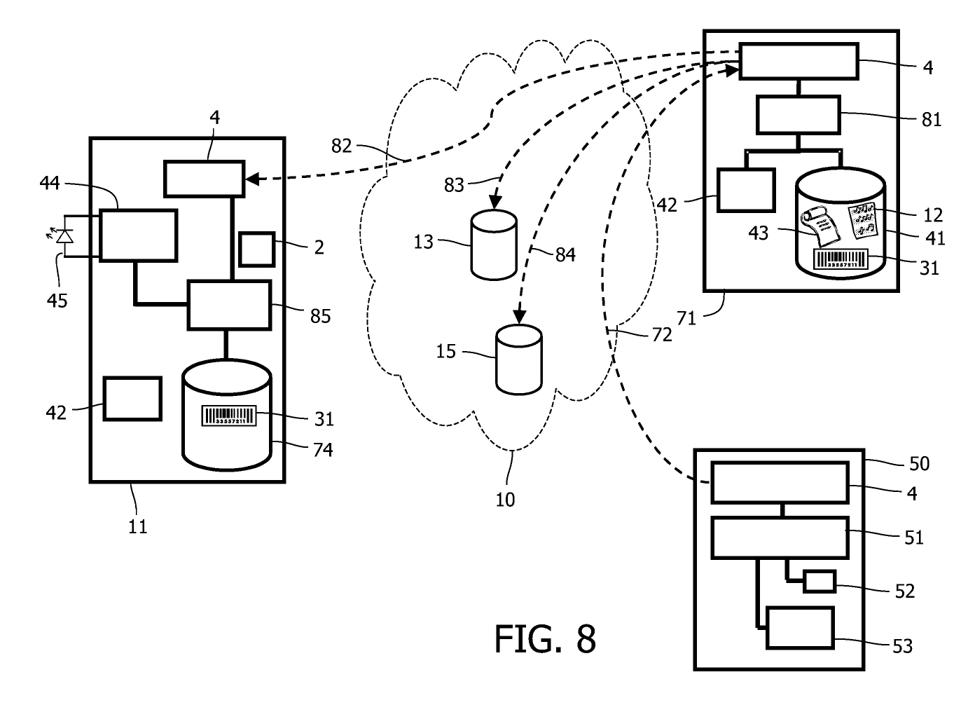

In the embodiment of FIG. 8 the storage server 71 comprises a query relevance processor 81 that accepts the query for content to be located 72 produced by the user interface device 50. The query relevance processor 81 is capable of locating the content 12, if possible, i.e. when it is stored within the storage unit 41. The query relevance processor 81 is further capable of attaching a relevance factor for each device comprised within the network 10 to the result of processing the query for content to be located 72 which indicates how relevant the content 12 is to a particular device. The particular device can be further identified using the identifying means 31 associated with the content 12, as in the embodiment of FIG. 7. This relevance therefore enables the system to provide more qualitative results to the query for content to be located 72. Attaching a relevance to the results of a query is commonly provided by Internet search engines, such as Google, to provide a ranking. This is advantageous since the user 9 does not need to explicitly define the content 12 to be located and can provide a less exact identification of the content 12.

The query relevance processor 81 transmits a first relevance factor 82 to the first device 11, a second relevance factor 83 to the second device 13 and a third relevance factor 84 to the third device 15. In the embodiment of FIG. 8 the first device 11 is shown to comprise a relevance indicator processor 85 coupled to the input of the visual controller 44. The relevance indicator processor 85 is arranged to indicate that the content has been located and that the first device 11 has been identified to generate an indication that the user 9 is physically susceptible to. The relevance indicator processor 85 is further arranged to use the first relevance factor 82 and scale the control signal provided to the visual controller 44, such that the visual controller 44 can provide a further signal to the visual indication means 45 that is in agreement with the first relevance factor 82. Numerous relationships are possible between the relevance factor and the resulting visual indication, such as, a linear relationship or a logarithmic relationship and these relationships are equally applicable to other forms of physical indication. The user 9 can then easily locate the first device 11 which, in this example, has the highest relevance to the content 12 to be located. The second device 13 and the third device 15 may be of some relevance to the initial query created by the user 9 and would respond appropriately. In implementing the relevance indicator processor 85 a general-purpose processor 2 and memory 42 can be used.

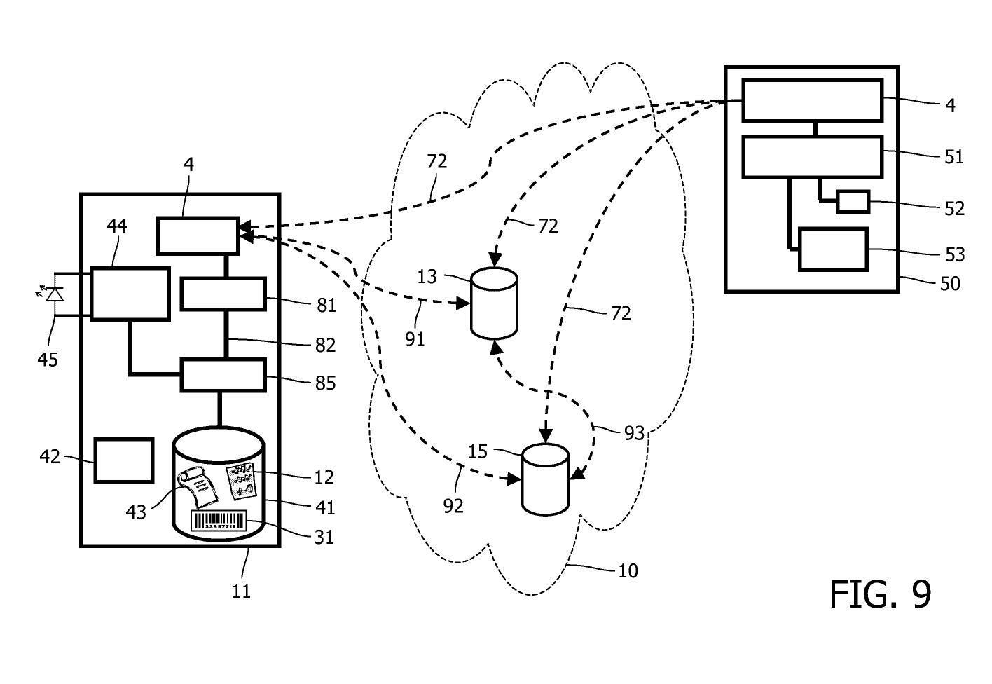

In the embodiment of FIG. 9 the user interface device 50 accepts input from the user 9 identifying content 12 to be located. The query for content to be located 72, first introduced in the description of FIG. 7, is transmitted throughout the network 10. In this example, this is to the first device 11, the second device 13 and the third device 15. The first device 11 is shown to comprise the query relevance processor 81, described earlier. The query relevance processor 81 produces a first relevance factor 82 which depends on how relevant the content 12 is to the first device 11. The second device 13 may produce a second relevance factor 83 and the first device 11 and the second device 13 may exchange the relevance factors during a first exchange of relevance factors 91. Equally, the third device 15 may produce a third relevance factor 84 and the first device 11 and the third device 15 may also exchange these relevance factors during a second exchange of relevance factors 92. The second device 13 and the third device 15 may also exchange relevance factors during a third exchange of relevance factors 93. In such a way, each device may comprise a relevance indicator processor 85 that is further capable of adjusting the output of the control signal to a corresponding visual controller 44 such that account is taken of the relevance factors from all devices with respect to the content 12 to be located. For example, a winner takes all approach could be implemented whereby only the most relevant device provides a physical indication to the user 9. A further option is that each device responds with a physical indication that is proportional to a final relevance result calculated from a ratio of the relevance factor for a specific device to the average relevance factor over all of the devices.

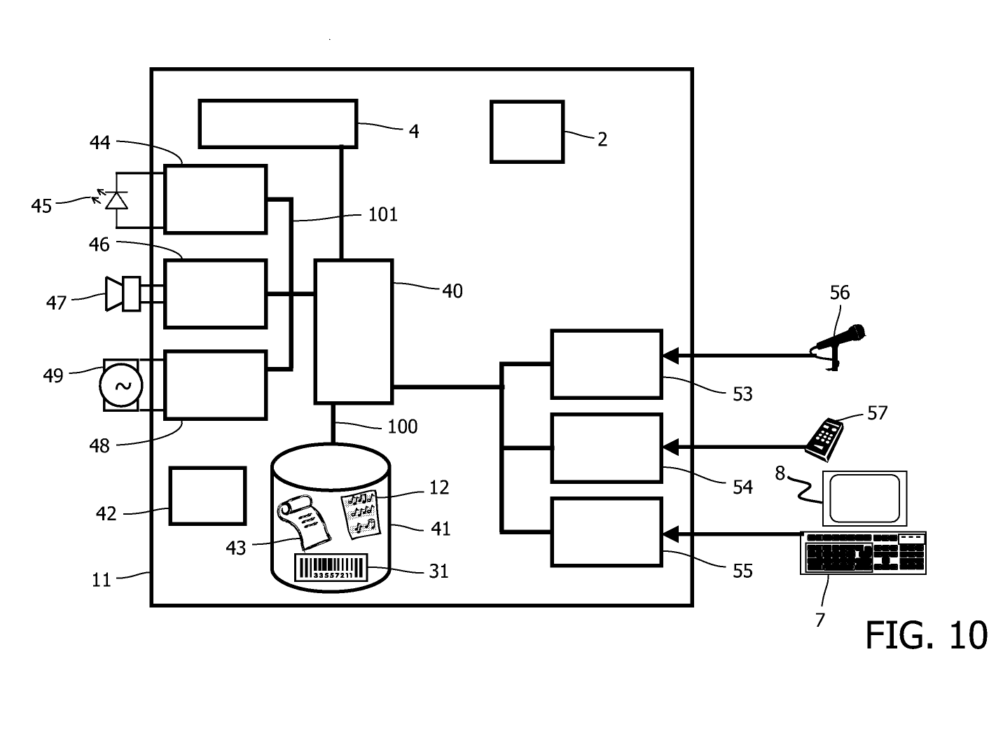

In the embodiment of FIG. 10 the first device 11 can operate independently from other devices comprised within the system yet act according to the invention. The first device 10 is shown to comprise a voice input processor 53 connected to an acoustic input 56, such as a microphone, a remote control input processor 54 and a keyboard input processor 55 all capable of interacting with the user 9 to identify content 12 to be located. The first device 11 further comprises a query processor 40 to execute a local query 100 on the storage unit 41, the storage unit 41 further comprising the content 12, metadata 43 and an identifying means 31. A content located upon device output 101, or more generally a content located output, is passed to multiple indication controllers, namely a visual controller 44, an acoustic controller 46 and a vibration controller 48. These indication controllers generate suitable signals for the respective physical indication means, namely the visual indication means 45, the acoustic indication means 47 and the vibrational indication means 49. Any or all of the physical indication means are capable of identifying to the user 9 that the content 12 is located upon the first device 11. The communication means 4 may be used to communicate the results of the query results from the query processor 40 to other devices comprised within the network 10 and may also be used to generate results which indicate a relevance of the query results to those produced by other devices comprised within the network 10. The general-purpose processor 2 and memory 42 may be used to implement any of the processors or controllers described above.

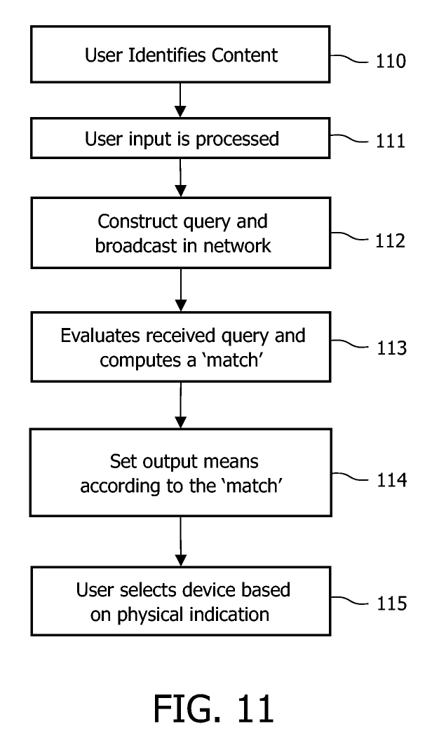

FIG. 11 illustrates an example flow diagram for physically locating content in a network that may be embodied in the at least one processor 2 indicated in the embodiments of FIG. 3, FIG. 5, FIG. 6, FIG. 9 or FIG. 10.

In method step 110 the user 9 inputs a request for ‘content indication’ to a device, such as a TV device, a user device 1, a personal computer or a user interface device 50. This could be done via speech, or keyboard, or remote control operations on an on-screen display, or a combination thereof. For example, the user 9 could use a remote control device 57 to select the menu item ‘physically locate content’ and press OK. In method step 111 the input from the user 9 can optionally be pre-processed if it is in a raw format, for example, if the user gives a voice command via microphone, such as, ‘where is music?’ a processor 2 may convert this into a string ‘LOCATE: music’.

In method step 112 a processor 2 constructs a query from the pre-processed user input. A message containing a request for content indication and the constructed query is broadcast to all devices on the network 10. For example, the string ‘LOCATE: music’ may be converted to a standardized query format, such as SQL, SELECT*WHERE ContentType=‘audio/music’. In step 113 each device on the network 10 can receive the message and query that was broadcast. A processor may be arranged to take the message, extract the query expression from it, and evaluate the query using the metadata stored in storage, local to the device. A local database engine, for example, one that takes SQL as input, may perform the query evaluation. The local database engine can provide a query result, for example, in SQL an integer number Nm of matching metadata items in the result set. Here Nm is bounded by the total number of metadata items present in the device, Nm <=Ntot. The match value is then computed as m=Nm/Ntot.

In method step 114 the match value resulting from step 113 is passed to one or more indication controllers, such as, a visual controller 44, an acoustic controller 46 and/or a vibration controller 48. These activate the visual indication 45, the acoustic indication 47, and the vibrational indication 49 respectively. The choice of these output modalities may be pre-defined by the user at an earlier time. During step 114 the indication controllers can set the intensity of the output activator proportional to the resulting match value. For example, 0 is no activation at all, and 1 is maximum activation. The maximum may be user-predefined. Any of the indication controllers may also apply a shaping function F to the output, for example, the physical indication may be set to F(match) to make the output more pleasant for the user. The function F may be the logistic function

$$F ( x ) = a \frac{1 + m {e}^{- x / t}}{1 + n {e}^{- x / t}}$$

with parameters a, m, n, t to be chosen for the desirable effect.

For a visual indication a light output pattern may depend on the activation value wherein for high values, a LED could blink fast, while for low values, the LED could just light up infrequently. For an acoustic indication a sound output type may depend on the activation value wherein for low values, no sound is produced, while for higher values, a pleasant repeated ‘ding dong’ sound is produced. For even higher values a faster beeping sound can be produced.

Finally, in step 115, the user 9 notices the device, or devices, that produce the most sound/light/vibration output. The user 9 can now identify and pick up the device(s) and start browsing or rendering the content 12 to be located. The user 9 can also take the device(s) with him/her outside the home. If many of the storage devices show similar content indications, or no device at all generates a physical indication that is visible, audible or can be felt, then the user knows that there is no single device clearly storing the content he/she was looking for.

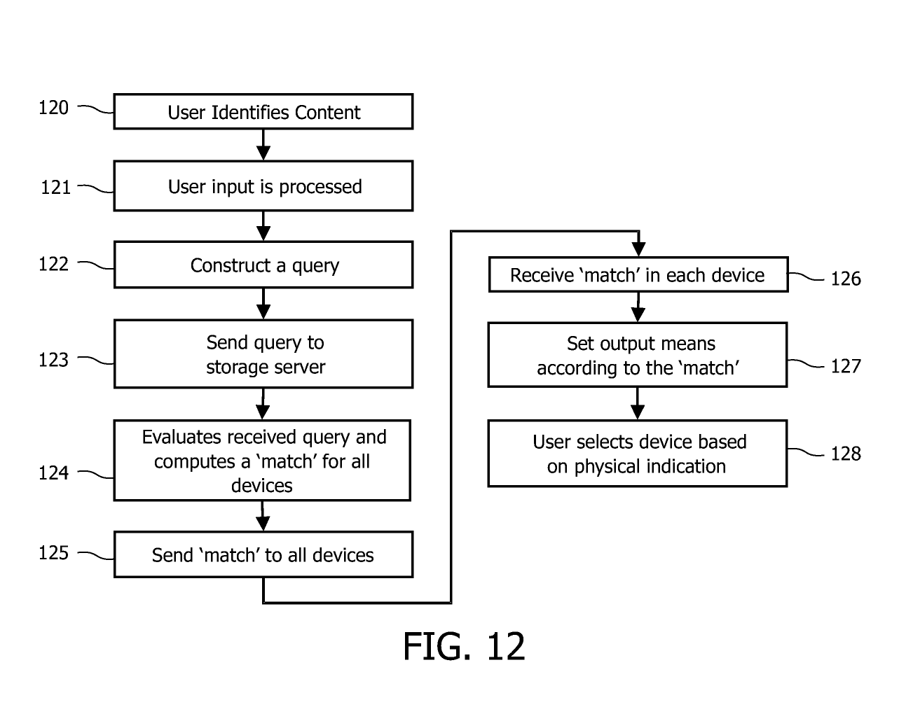

FIG. 12 illustrates an example flow diagram for physically locating content in a network that may be embodied in the at least one processor 2 indicated in the embodiments of FIG. 7 or FIG. 8.

In method step 120 the user 9 inputs a request for ‘content indication’ to a device, such as a user interface device 50. In method step 121 the input from the user 9 can optionally be pre-processed if it is in a raw format. In method step 122 a processor can construct a query from the pre-processed user input. In method step 123 a message containing a request for content indication and the constructed query is broadcast to a storage device 71 on the network 10. For example, the string ‘LOCATE: music’ may be converted to a standardized query format, such as SQL, SELECT*WHERE ContentType=‘audio/music’. In step 124 each device on the network 10 can receive the message and the query that was broadcast. Preferably the method steps 120, 121, 122 and 123 are performed in a user interface device 50. However, they may also be preformed in a first device 11, or in a storage server 71, dependent upon the embodiment chosen.

In step 124 a processor may be arranged to take the message, extract the query expression from it, and evaluate the query using the metadata stored in storage, local to the device. The query can be performed on behalf of all devices comprised within the network 10, i.e. in a centralized manner. A database engine, for example, one that takes SQL as input, may perform the query evaluation. The local database engine can provide a query result, for example, in SQL an integer number Nm,i of matching metadata items related to the content linked to device i in the result set. Here each Nm,i is bounded by the total number of metadata items present in each device, Nm,i<=Ntot,i. The match value is then computed as mᵢ=Nm,i/Ntot,i. In method step 125 the match value mᵢ resulting from step 124 is transmitted to each respective device i comprised within the network 10. Preferably the method steps 124 and 125 are performed in a storage server 71. However, they may also be preformed in a first device 11, or in a user interface device 50, dependent upon the embodiment chosen.

In step 126 each device comprised within the network 10 receives the message produced in step 125. A processor is again arranged to pass the message to one or more indication controllers, for use in step 127, such as, a visual controller 44, an acoustic controller 46 and/or a vibration controller 48. These activate the visual indication 45, the acoustic indication 47, and the vibrational indication 49 respectively. The choice of these output modalities may be pre-defined by the user at an earlier time. During step 127 the indication controllers can set the intensity of the output activator proportional to the resulting match value. For example, 0 is no activation at all, and 1 is maximum activation. The maximum may, again, be user-predefined. Any of the indication controllers may also apply a shaping function F to the output.

Finally, the user 9 notices, in step 128, the device(s) which produce the most sound/light/vibration output. The user 9 can quickly identify and pick up the device(s) and start browsing or rendering the content 12 to be located. The user 9 can also take the device(s) with him/her outside the home. Preferably, the device(s) can also make use of a network connection to enable access to the content 12 from a remote location. Again, if many of the storage devices show similar content indications, or no device at all generates a physical indication that is visible, audible or can be felt, then the user knows that there is no single device clearly storing the content he/she was looking for.

It should be noted that the above-mentioned embodiments illustrate rather than limit the invention, and that those skilled in the art will be capable of designing many alternative embodiments without departing from the scope of the invention as defined by the appended claims. Furthermore, any of the embodiments described comprise implicit features, such as, an internal current supply, for example, a battery or an accumulator. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage. The terms “data” and “content” have been used interchangeably through the text, but are to be understood as equivalents.

1. A system (1, 11, 50, 71) for physically locating content (12) in a network (10) comprising:
means (2, 3, 4, 5, 40, 42) for identifying a physical device (11) within the network (10) upon which the content (12) is stored having an input (7, 56, 57) for identifying the content to be physically located and having an output (31) identifying the physical device (11); and
means (2, 3, 30, 42, 44, 46, 48) for generating a user susceptible physical indication (45, 47, 49) on the physical device (11) identified by the means for identifying a physical device.

2. The system of claim 1 wherein:
the means for identifying a physical device further comprises:
means (81) for generating a relevance factor (82) having an input communicatively coupled to the input for identifying the content to be physically located and having an input communicatively coupled to the output identifying the physical device and having the relevance factor (82) as an output wherein the relevance factor (82) indicates a relevance of the content to the physical device; and
wherein:
the means for generating a user susceptible physical indication generates the user susceptible physical indication (45, 47, 49) in accordance with the relevance factor (82) from the means (81) for generating a relevance factor.

3. The system of claim 1 wherein:
the means for identifying a physical device further comprises:
means (4, 5, 50, 51) for generating a query (20, 72) within the network having an input communicatively coupled to the input for identifying the content to be physically located and having the query as an output;
means (5, 40) for performing the query (20, 72) within the network having an input for receiving the query from the means for generating a query and having a query result (73, 82, 83, 84) as an output; and
wherein
the means for generating a user susceptible physical indication generates the user susceptible physical indication further in accordance with the query result from the means for performing the query.

4. The system of claim 2 wherein:
the means (81) for generating a relevance factor (82) further comprises an input communicatively coupled (4, 10) to at least one other device (13, 15) comprised within the network for receiving at least one further relevance factor (91, 92) from the at least one other device; and
wherein:
the means for generating a user susceptible physical indication generates the user susceptible physical indication (45, 47, 49) further in accordance with the at least one further relevance factor from the means (81) for generating a relevance factor.

5. The system of claim 3 wherein
the means for generating a query further comprises:
means (7, 53, 54, 55) for inputting a request for content to be physically located and wherein the means for inputting a request is a selection of at least one of the following:
an acoustic input device (56);
a remote control device (57);
a keyboard device (7);
a pointing device; or
a visual input device.

6. The system of claim 3 wherein:
the means (51) for generating a query (20) is located in a first device (50);
the means (40) for performing the query (20) is located in a second device (71); and
the means (44, 45, 46, 47, 48, 49) for generating a user susceptible physical indication is located in a third device (11).

7. The system of claim 3 wherein:
the means (51) for generating a query (20) is located in a first device (50); and
the means (40) for performing the query (20) and
the means (44, 45, 46, 47, 48, 49) for generating a user susceptible physical indication are located in a second device (11).

8. The system of claim 3 wherein the user susceptible physical indication is a selection of at least one of the following:
a visual indication (45);
an acoustic indication (47);
a vibrational indication (49).

9. A device (11) for physically locating content (12) in a network (10) comprising:
means (2, 4, 40, 42, 74) for identifying that the content (12) has been located and having a content located output (39, 76, 101); and
means (2, 30, 42, 44, 46, 48) for generating a user susceptible physical indication (45, 47, 49) on the device (11) in response to the content located output from the means for identifying that the content has been located.

10. The device of claim 9 wherein:
the means for identifying that the content has been located further comprises:
means (2, 40, 42, 81) for generating a relevance factor (82) having an input communicatively coupled to the content located output and having the relevance factor (82) as an output wherein the relevance factor (82) indicates a relevance of the content to the device (11); and
wherein:
the means for generating a user susceptible physical indication further comprises a relevance indicator processor (85) arranged to generate the user susceptible physical indication in accordance with the relevance factor (82) from the means for generating a relevance factor.

11. The device of claim 9 wherein:
the means for identifying that the content has been located further comprises:
means (40) for generating a query (100) within the device having an input (53, 54, 55) for identifying the content to be physically located and having the query (100) as an output;
means (2, 40, 42) for performing the query (100) within the device having an input for receiving the query (100) from the means for generating a query and having a query result (39) as an output; and
wherein
the means for generating a user susceptible physical indication generates the user susceptible physical indication further in accordance with the query result (39) from the means for performing the query.

12. The device of claim 11 further comprising:
a storage unit (41), the storage unit comprising the content (12) and metadata (43), the metadata being related to the content
wherein:
the means for performing the query (100) within the device (11) is communicatively coupled to the storage unit; and is arranged to perform the query (100) making use of the metadata (43).

13. The device of claim 11 wherein the user susceptible physical indication is a selection of at least one of the following:
a visual indication (45);
an acoustic indication (47);
a vibrational indication (49).

14. A method of physically locating content (12) within a network (10), the method comprising the method steps of:
identifying (110, 111, 120, 121) the content in the network which is to be physically located;
identifying (112, 113, 122, 123, 124, 125, 126) a physical device upon which the content is located; and
generating (114, 127) a user susceptible physical indication on the physical device upon which the content is located.

15. The method of claim 14 wherein
the method step of identifying a physical device upon which the content is located further comprises the method step of:
generating (113, 124) a relevance factor based upon a relevance of the content to the physical device; and
wherein:
the method step of generating a user susceptible physical indication further comprises the method step of generating (114, 127) the user susceptible physical indication in accordance with the relevance factor.

16. The method of claim 14 wherein
the method step of identifying the content in the network which is to be physically located further comprises the method steps of:
receiving (110, 120, 121) input from a user, the input identifying the content in the network which is to be physically located; and wherein
the method step of identifying a physical device upon which the content is located further comprises the method steps of:
constructing (112, 122) a query based upon the input from the user;
communicating (112, 123) the query within the network;
performing (113, 124) the query and generating (113, 124) a query result (73, 91, 92, 93) on at least one device comprised within the network; and
wherein
the method step of generating a user susceptible physical indication further comprises the method step of generating (114, 127) the user susceptible physical indication in accordance with the query result.

17. The method of claim 16 wherein
the method step of identifying the content in the network which is to be physically located further comprises the method step of:
transmitting (125) the query result to at least one device comprised within the network; and
wherein
the method step of generating a user susceptible physical indication further comprises the method step of:
receiving (126) at least one further query result from at least one device comprised within the network; and wherein
the method step of generating a user susceptible physical indication further comprises the method step of generating (114, 127) the user susceptible physical indication in accordance with the query result and the at least one further query result.

18. A computer program product directly loadable into the memory of a programmable device, comprising software code portions for performing the steps of a method according to claim 14 when said product is run on the device.
